(19) United States
(12) Patent Application Publication
(10) Pub. No.: US 2023/0264379 A1
(43) Pub. Date: Aug. 24, 2023

(54) BUNDLE BREAKER INCLUDING A PLATEN HAVING A COMPRESSIBLE BOTTOM SURFACE

(71) Applicant: A. G. Stacker Inc., Weyers Cave, VA (US)

(72) Inventors: Joseph WUNDER, Lexington, VA (US); Jerry BLOSSER, Crimora, VA (US); Randall Donn SENGER, Mount Sidney, VA (US)

(21) Appl. No.: 18/112,206

(22) Filed: Feb. 21, 2023

Related U.S. Application Data
(60) Provisional application No. 63/312,421, filed on Feb. 22, 2022.

(51) Int. Cl. B26F 3/00; B26D 7/04

(52) U.S. Cl. CPC B26F 3/002; B26D 7/04; B26F 2210/02; B26D 7/0625

(57) ABSTRACT

A bundle breaker includes first and second platens located above upstream and downstream breaking supports and first and second actuators configured to move the platens to selectively clamp logs between the platens and the breaking supports. A third actuator moves the second breaking support relative to the first breaking support to break bundles off the log. A foam sheet is attached to the bottom of each of the first and second platens and is configured to be compressed when the logs are clamped. The bottom surfaces of the foam sheets are preferably at least partially coated with an elastomeric coating or at least partially covered by an elastomeric sheet.

### CROSS-REFERENCE TO RELATED APPLICATIONS

The present application claims the benefit of U.S. Provisional Patent Application No. 63/312,421, filed Feb. 22, 2022, the contents of which are hereby incorporated by reference.

### TECHNOLOGICAL FIELD

The present disclosure is directed to a bundle breaker including a platen having a compressible material on its bottom surface, and, more specifically, to a bundle beaker including a platen having a polymer foam material attached to its bottom surface.

### BACKGROUND

Many products are manufactured in elongated sheets that can be separated into individual blanks along scored or perforated or partially cut lines. For example, corrugated paperboard blanks, from which boxes and other structures may subsequently be formed, are often formed in this manner.

An elongated sheet of corrugated paperboard may be divided by score lines into, e.g., five separate blanks. The score lines generally run transversely, that is, perpendicular to the length of the elongated sheet. When a plurality of the sheets (sometimes referred to as “boards”) are arranged in a stack, the score lines are aligned vertically. Such a stack of elongated sheets made up of individual blanks may be referred to as a “log.” During the processing of logs, it is necessary to break individual stacks of sheets from the log along the vertically aligned score lines (sometimes referred to as a “breaking plane” or “breaking junction”). A stack of sheets that has been broken off a log may be referred to as a “bundle.” The individual portions of the log that will be broken off the log may also be referred to as “bundles” even when they are still attached to each other in the log. Therefore, a log will comprise a plurality of bundles joined together at transverse score lines which bundles can be broken off the log one at a time to form individual bundles.

Machines that receive logs and break individual bundles from the logs are known as “bundle breakers.” A bundle breaker generally includes two bottom support sections, each of which may include a conveyor, and two platens, one mounted over each support section. In operation, a log is moved along the bundle breaker until a score line between a first bundle of the log and a second bundle of the log is arranged at a junction of the first conveyor and the second conveyor, and the first bundle is then clamped against the downstream support section by the first platen and the second portion of the log is clamped against the upstream support section by the second platen. An actuator then shifts one of the support sections, usually the downstream support section, relative to the other support section to break the log along the score lines and separate the first bundle from the log. That first bundle is then moved away from the remaining portion of the log, and the log is shifted further downstream until the score lines separating the second bundle of the log from the third bundle of the log arrives at the breaking location at which time the process repeats until all bundles that formed the original log have been separated.

Some bundle breakers are configured to break bundles from multiple logs at the same time. That is, a plurality of logs may be arranged in parallel across the bundle breaker with the score lines separating the downstream-most bundle of each log from the rest of the respective log located at the junction of the upstream and downstream support sections. The multiple logs may be simultaneously clamped by the platens against the support sections by the first and second platens and broken simultaneously by the movement of the downstream support section relative to the upstream support section.

When multiple logs need to be broken simultaneously by the bundle breaker, it is generally desirable that all logs include the same number of elongated sheets and are thus the same height. The platens can then be moved into a predetermined position to apply the same pressure to each of the logs during the breaking process. However, it sometimes occurs that the heights of the logs are not identical, for example, when one log contains fewer sheets that the others. In such case, the amount of force applied against the logs by the platens must be sufficient to secure the shortest log for proper breaking without being so great that it partially crushes sheets in the taller logs.

It would therefore be desirable to provide a bundle breaker that is less likely to damage logs while they are being held in place by a movable platen, especially when the heights of the logs differ.

### SUMMARY

This problem is addressed by the present disclosure by attaching a sheet of compressible material, specifically a polymer foam material, and more specifically, a polyurethane foam material, to the lower side of the platens of the bundle breaker. When logs having different heights are present on the bundle breaker and the platens apply a given force against the logs, the comformability or compressibility of the foam reduces the difference in pressures applied to each of the logs. When the platen is moved to apply sufficient pressure against the shortest stack of logs, the tallest stack will be pressed further into the foam which will reduce damage to the tall log as compared to the use of a rigid platen which would tend to crush the tallest log when a downward pressure is applied that is adequate to hold the shortest log in place. Furthermore, as the logs form depressions in the foam, the walls of the depression may help prevent lateral movement of the upper sheets of the logs relative to the platens and thus may help secure the logs while minimizing the compressive force required to hold the logs in place.

A first aspect of the present disclosure comprises a bundle breaker that includes an upstream breaking support and a downstream breaking support each having an input end and an output end, a first platen located above the upstream breaking support and a second platen located above the downstream breaking support. A first foam sheet is attached to the bottom of the first platen, and a second foam sheet is attached to the bottom of the second platen. The foam sheets each have a bottom surface facing the respective breaking support. A first actuator is operably connected to the first platen and a second actuator is operably connected to the second platen, and each actuator is configured to shift the respective platen toward a raised position above a breaking support and toward a lowered position above a breaking support to selectively clamp a first portion of a log between the foam sheet and the breaking support. A third actuator is configured to shift the input end of the downstream breaking support relative to the output end of the upstream breaking support from a first position to a second position to break the second portion of the log from the first portion of the log. In addition, the bottom surface of the first foam sheet and/or the bottom surface of the second foam sheet is at least partially coated with an elastomeric coating or at least partially covered by an elastomeric sheet.

Another aspect of the present disclosure comprises a bundle breaker that includes an upstream breaking support and a downstream breaking support each having an input end and an output end, a first platen located above the upstream breaking support and a second platen located above the downstream breaking support. A first foam sheet is attached to the bottom of the first platen, and a second foam sheet is attached to the bottom of the second platen. The foam sheets each have a bottom surface facing the respective breaking support. A first actuator is operably connected to the first platen and a second actuator is operably connected to the second platen, and each actuator is configured to shift the respective platen toward a raised position above a breaking support and toward a lowered position above the breaking support to selectively clamp a first portion of a log between the foam sheet and the breaking support. A third actuator is configured to shift the input end of the downstream breaking support relative to the output end of the upstream breaking support from a first position to a second position to break the second portion of the log from the first portion of the log. A tensile strength of the first foam sheet and/or the second foam sheet is at least 15 psi, and the first foam sheet and/or the second foam sheet is configured to be compressed 10% by a load of 2.6 psi and to be compressed by 50% at a load of 3.4 psi.

### BRIEF DESCRIPTION OF THE DRAWINGS

These and other aspects and features of the invention will be better understood after a reading of the following detailed description in connection with the attached drawings wherein:

FIG. 1 is a perspective view of a bundle breaker according to an embodiment of the present disclosure.

FIG. 2 is a side elevational view of the bundle breaker of FIG. 1 showing a log supported by the bundle breaker with a first portion of the log positioned between an upstream breaking conveyor and a first platen and a second portion of the log positioned between a downstream breaking conveyor and a second platen.

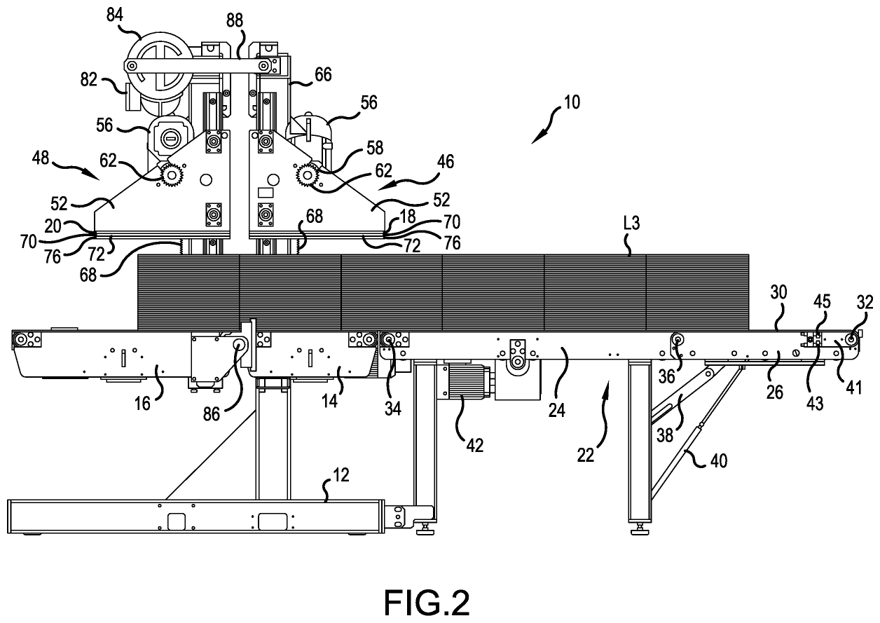

FIG. 3 is a side elevational view of the bundle breaker of FIG. 2 showing the first platen pressing the first portion of the log against the upstream breaking conveyor and the second platen pressing the second portion of the log against the downstream breaking conveyor.

FIG. 4 is a side elevational view of the bundle breaker of FIG. 2 showing the downstream breaking conveyor shifted relative to the upstream breaking conveyor and the second portion of the log broken off the first portion of the log.

FIG. 5 is side elevational view of the bundle breaker of FIG. 2 showing the downstream breaking conveyor returned to a starting position with its top surface substantially coplanar with the top surface of the upstream breaking conveyor and the second portion of the log moved away from the first portion of the log.

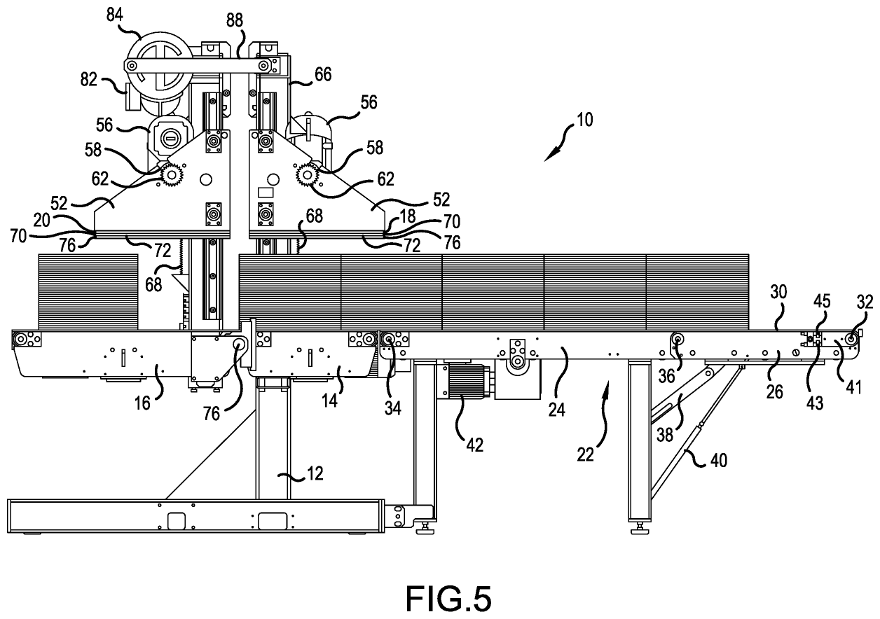

FIG. 6 is a rear elevational view of a support frame and drive for moving the second platen. A foam sheet is mounted to the bottom surface of the second platen, and a flexible membrane is mounted on the bottom surface of the foam sheet.

FIG. 7 is rear elevational view of a support frame and drive for moving the second platen. A foam sheet is mounted to the bottom surface of the second platen, and the bottom of the foam sheet is coated with an elastomeric coating.

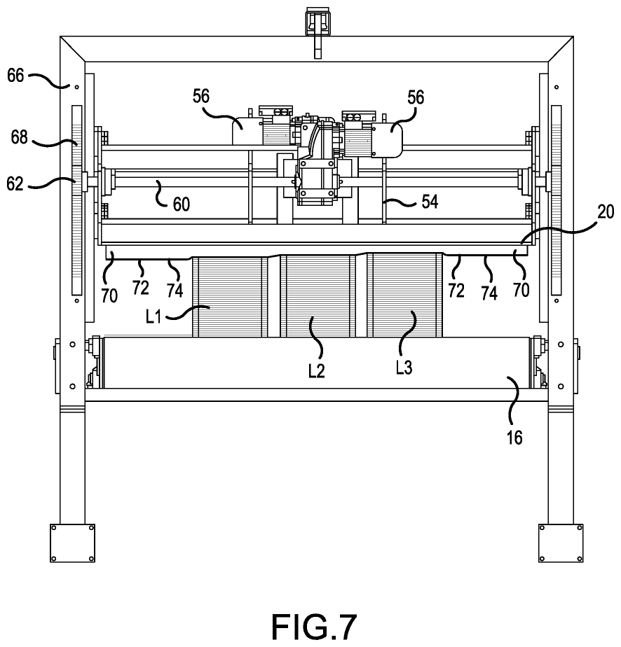

### DETAILED DESCRIPTION

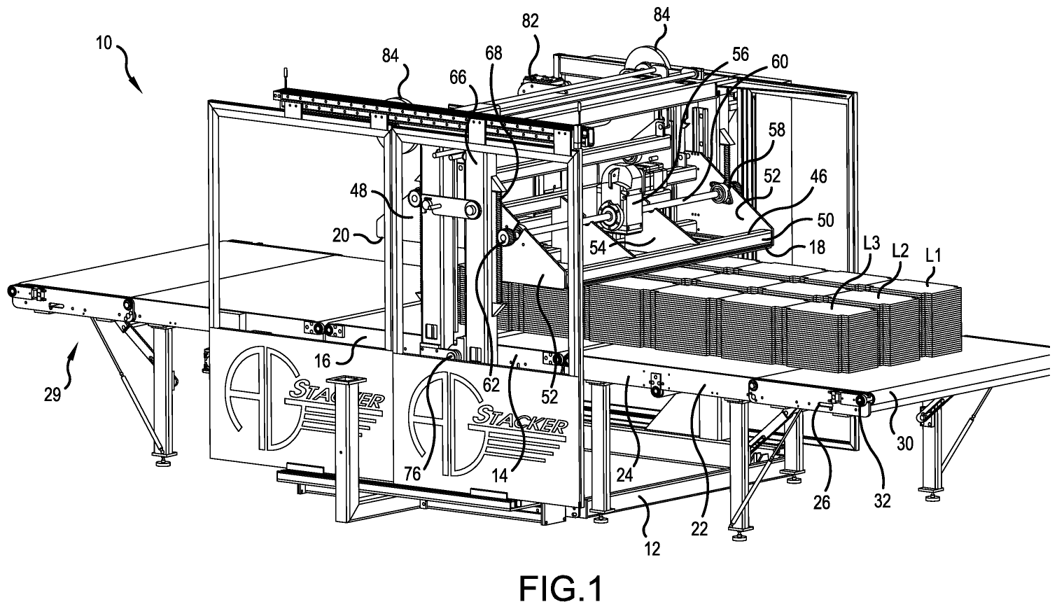

Referring now to the drawings, wherein the showings are for purposes of illustrating presently preferred embodiments of the invention only and not for the purpose of limiting same, FIG. 1 shows a bundle breaker 10 according to the present disclosure. The bundle breaker 10 includes a frame 12 supporting an upstream breaking conveyor 14 and a downstream breaking conveyor 16. A first platen 18 is mounted to the frame 12 above the upstream breaking conveyor 16, and a second platen 20 is mounted to the frame 12 above the downstream breaking conveyor 16.

The bundle breaker 10 includes an input conveyor 22, and the input conveyor 22 has an output section 24 connected to an input end of the upstream breaking conveyor 14 and an input section 26. The input section 26 can be raised and lowered relative to the output section 24 to allow an operator to easily pass through the bundle breaker to reach the other side of the bundle breaker. The input conveyor 22 includes a continuous belt 30 supported by an input end support shaft 32, an output end support shaft 34 and a center support shaft 36, the center support shaft 36 being located at a hinged connection between the input section 26 and the output section 24. A lock bar 38 holds the input section 26 in the raised position, and a gas spring 40 helps control the transition of the input section 26 from the raised to the lowered position.

The input end support shaft 32 is mounted between two plates 41 which plates 41 are each slidably mounted on a pair of rods 43 and biased away from the output section 24 by a pair of springs 45. The force produced on the input end support shaft 32 maintains a suitable tension on the belt 30 during use.

The first platen 18 is connected to the frame 12 by a first platen support 46, and the second platen 20 is connected to the frame 12 by a second platen support 48. The first platen support 46 will primarily be discussed hereafter, it being understood that the second platen support 48 is substantially identical thereto. The first platen support 46 includes a bottom frame 50 to which the first platen 18 is attached, first and second side plates 52, a motor mount 54 supported by the bottom frame 50 at a location between the first and second side plates 52 and a motor 56 supported by the motor mount 54. Each of the side plates 52 has inner sides that face the motor 56 and outer sides that face away from the motor 56. Each of the side plates includes a notch 58, and a drive shaft 60 extends from either side of the motor 56 through the notches 58. A drive gear 62 is mounted at each end of the drive shaft 60 on the outer sides of the side plate 52.

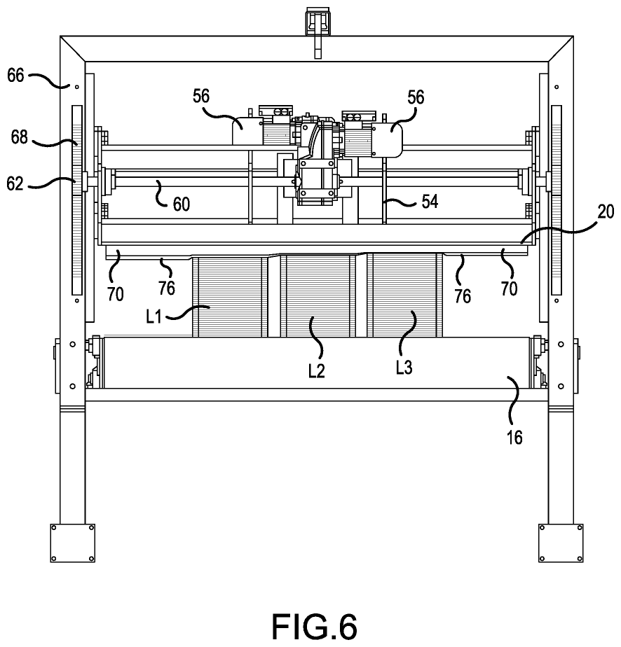

Referring now to FIG. 6, first and second vertical members 66 of the frame 12 of the bundle breaker 10 each include a rack 68 which racks 68 are engaged by the drive gears 62 when the first platen support 46 is mounted to the frame 12. The racks 68 are located on one side of the vertical member 66 while the guide wheels 64 are located on an opposite side of the vertical members 66. Driving the motor 56 in first and second directions rotates the drive shaft 60 and thus the drive gears 62 in first and second directions so as to move the first platen support frame 46 up and down along the vertical members 66 and thus move the first platen 18 away from and toward the upstream breaking conveyor 14 opposite the first platen 18.

The motor 56 preferably comprises a servo gear motor that is controllable by torque feedback. A servo motor available from Siemens under the brand name/model number SIMOTICS S-1FK7 is suitable for use in the present disclosure. This motor is driven electrically and can be set to apply a predetermined limit for the torque to the drive shaft 60, for example, by monitoring the current and/or voltage at the motor to determine the motor output torque. The current and/or voltage can be monitored by a sensor in the motor itself or by an outside sensor contained, for example, in a controller that controls the overall operation of the bundle breaker. In this manner, the amount of downward force exerted by the first and second platens 18, 20 against a log on the upstream and downstream breaking conveyors 14, 16 beneath the first and second platens 18, 20 can be controlled, and the force can be set so as not to exceed a force that would damage the individual sheets that form the log. The torque limit can be adjusted based on the characteristics of the sheets and/or logs being processed. The controller can comprise a microprocessor or other circuitry configured to send control signals to and receive status signals from various components of the bundle breaker 10.

A polymer foam sheet 70 is attached to the bottom 72 of each of the first and second platens 18, 20 by a suitable adhesive or fasteners. FIG. 6 shows the polymer foam sheet 70 on the second platen 20 of the downstream breaking conveyor 16. As will be apparent from this Figure, the log L3 is taller (contains more sheets) than the log L2, and the log L2 in turn is taller than the log L1. When the second platen 20 is lowered to a position that provides adequate holding force for the shortest log L1, the top sheets of the logs L2 and L3 are pressed into the polymer foam sheet 70. The cushioning provided by the polymer foam sheet 70 limits the amount of force experienced by the taller logs, and the polymer foam sheet 70 thus prevents or minimizes damage to the taller logs that might occur if rigid planar platens were used without the polymer foam sheet 70. An open cell polyurethane foam is presently preferred for use as the polymer foam sheet; however, the disclosure is not limited to the use of polyurethane foam and other open and closed cell foam materials may be substituted therefor without exceeding the scope of this disclosure if they exhibit the properties discussed below which provide adequate clamping and durability without damaging the logs being clamped.

In practice, it may be necessary to accommodate about a 0.25 inch difference in height between the shortest log L1 and the tallest log L3. Thus, for example, if the log L3 is 0.25 inches taller than the log L1 and the polymer foam sheet 70 is about 1 inch thick, the portion of the polymer foam sheet 70 above the log L3 will be compressed by about 50 percent while the portion of the polymer foam sheet 70 over the log L1 will be compressed by about 25%.

A desirable polymer foam for accommodating uneven height logs must maintain a friction coefficient greater than or equal to the friction coefficient between the sheets themselves that make up a log. In practice, this coefficient is typically on the order of 0.6, but can vary widely based on the actual material and finish of the sheets.

With a normal force applied by the clamping process, the resulting frictional force allows bundles to broken from a log without the sheets that make up the log slipping relative to each other. Therefore, the minimum frictional force between sheets in a log must be transferred through the polymer foam sheet 70, and each adjacent sheet that makes up the log, all the way back to the machine frame. Since the polymer foam sheet 70 must also support these forces, it is important that the foam material have a tensile and/or shear strength greater than the force required to break the bundles from a log. For most typical applications, a minimum tensile strength of 10-15 psi has been found to be sufficient.

Two materials suitable for use as the polymer foam sheet 70 are polyurethane foam sheets available from the General Plastics Manufacturing Company of Tacoma, Wash., under the trademark Last-A-Foam® and tradenames EF-4003 and EF-4004. EF-4003 has a density of 3.0 pounds per cubic foot, a tensile strength of 19 psi, a compression set of −1.9% and a resilience of 33%. Furthermore, the compression load vs. deflection at 75° F. (using ASTM D-3574-11) for several degrees of compression is shown in the Table 1 below:

TABLE 1

| Compression | Stress (psi) |
|---|---|
| 10% | 2.6 |
| 20% | 2.7 |
| 30% | 2.8 |
| 40% | 3.0 |
| 50% | 3.4 |
| 60% | 4.2 |
| 70% | 5.9 |

In view of these properties of the polymer foam sheet 70, the amount of pressure required to compress the polymer foam sheet 70 is relatively constant at compressions of 10% to 50%, and therefore the force experienced by the logs under the polymer foam sheets 70 will be relatively constant even when the heights of the logs differ.

The polymer foam sheet 70 must be sufficiently durable to withstand repeated contact and compression during use. The surface of the polymer foam sheet 70 that is in contact with the log must also withstand the friction forces that occur when a bundle is broken from a log, and this surface is also susceptible to damage from conditions outside of the normal operation of the bundle breaker. Foam materials that are compliant enough to reliably clamp uneven logs are may also be damaged more easily that stiffer materials. Therefore, the bottom surface 72 of the polymer foam sheet 70 may optionally be provided with a protective coating 74 or a protective covering 76 to protect the polymer foam sheet 70 from damage without materially affecting the compressibility vs. deflection properties of the polymer foam sheet 70.

The protective coating 74 may comprise a rubberized coating. A suitable rubberized coating is available from McMaster-Carr under the name “Rubber Protective Coating.” The coating 74 may be applied as a solvent-based aerosol and have a thickness of approximately 5 mils. Other rubberized or elastomeric coatings may be applied in liquid form by brushing or rolling. The coating 74 may comprise natural rubber or a synthetic elastomer. Unless a particular distinction is made herein between natural and synthetic rubber, such as when natural rubber or a particular type of synthetic rubber is under discussion, the terms “elastomer” and “elastomeric” are intended to include both natural and synthetic materials having elastomeric properties.

Instead of applying the protective coating 74 to the bottom 72 of the sheet of polyurethane foam, a thin flexible membrane 76 may be attached to the bottom surface 72 of the polymer foam sheet 70. A suitable flexible membrane 76 is a sheet of ethylene propylene diene monomer (EPDM) rubber with a thickness of about 40 mils (not drawn to scale in the attached Figures). The flexible membrane 76 can be attached to the bottom surface 72 of the polymer foam sheet 70 by a suitable adhesive or by wrapping the edges of the flexible membrane 76 around the sides of the polymer foam sheet 70 and securing the flexible membrane 76 between the polymer foam sheet 70 and the first or second platen 18, 20.

The membrane 76 should be thin enough to conform, with the polymer foam sheet 70, to the different heights of the logs being compressed, but the membrane 76 at the same time needs to be resistant to damage (cuts, tears, punctures, etc.) in order to protect the underlying polymer foam sheet 70. A single-ply EPDM sheet that is about 40 mil thick satisfies these requirements. Preferably, the EPDM sheet is white to help reduce or prevent marking the surfaces of the logs. In addition, at least one side of the flexible membrane 76 may be textured to increase friction between the flexible membrane and the log. Natural rubber sheets or sheets formed from other elastomers can also be used as long as they are sufficiently durable and at the same time allow the polymer foam sheet 70 to conform to the shape of the logs.

The use of a motor 56 that can be controlled by torque feedback allows the benefits provided by the sheets of polyurethane foam 70 to be more fully realized. This is because the degree of compression of the polymer foam sheet 70 is related in a known manner to the pressure applied to the sheet, and the pressure can be precisely controlled by using torque feedback. Thus, for example, each clamping cycle can be controlled so that the polymer foam sheet 70 over the tallest log (or over all logs if they are of equal height) is compressed by about 50% of its thickness. In view of the known variance in log height of approximately one quarter inch, this ensure that the tallest logs are not damaged while the shortest logs are clamped with sufficient force to enable bundles to be cleanly broken off a log.

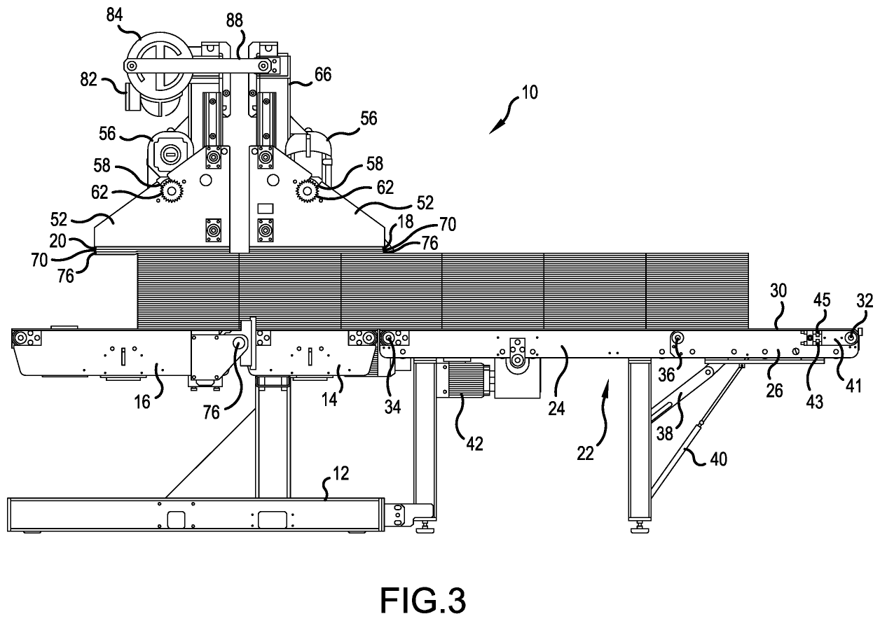

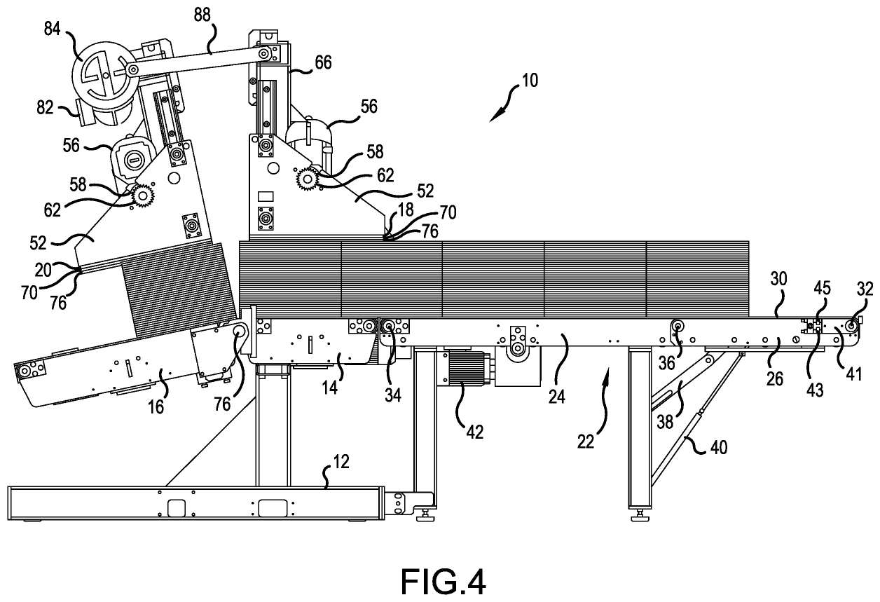

The bundle breaker 10 further includes a breaking motor 82 operably connected to a drive disk 84 both of which are mounted on the vertical frame members 66 of the downstream breaking conveyor 14. The breaking motor 82 is preferably also a servo gear motor with torque feedback similar or identical to the motors 56 used to raise and lower the first and second platen supports 46, 48. The downstream breaking conveyor 16 is pivotably connected to the upstream breaking conveyor 14 at a hinge 86. A connecting arm 88 is connected between a peripheral edge of the drive disk 84 and the vertical support 66 of the upstream breaking conveyor 14. The breaking motor 82 is configured to rotate the drive disk 84 from a first position illustrated in FIG. 3 to a second position illustrated in FIG. 4 which causes the downstream breaking conveyor 16 to pivot about the hinge 86 such that the top surface of the downstream breaking conveyor 16 is no longer substantially coplanar with the top surface of the upstream breaking conveyor 14.

The torque produced by the breaking motor 82 can be monitored to detect a change in the torque that indicates a break has occurred. For example, less force is required to move the drive disk 84 after a clamped bundle has been broken off a log. A drop in a detected torque to below a predetermined level can therefore be used to indicate that a break has occurred. A sudden drop in the torque produced by the breaking motor 82, detected by a sudden drop in current drawn by the breaking motor 82, for example, can also indicate that a break has occurred. The break may therefore be identified by detecting the rate at which the current changes.

The capability of servo motor 56 to provide precise torque control, and accurate feedback of the applied torque, for clamping logs is beneficial to ensure that the compression of the foam is maintained in the desired deflection range for optimal performance. Systems that utilize hydraulic or pneumatic clamping actions can also be used, but it is generally more difficult to achieve precise torque control with such systems.

The present invention has been described herein in terms of presently preferred embodiments. However, modifications and/or additions to these embodiments may become apparent to persons of ordinary skill in the art upon a review of the foregoing description. It is intended that all modifications and additions form a part of the present invention to the extent they fall within the scope of the several claims appended hereto.

What is claimed is:

1. A bundle breaker comprising:
an upstream breaking support having an input end and an output end,
a first platen located above the upstream breaking support,
a first foam sheet on the first platen having a bottom surface facing the upstream breaking support,
a first actuator operably connected to the first platen and configured to shift the first platen toward a raised position above the upstream breaking support and toward a lowered position above the upstream breaking support to selectively clamp a first portion of a log between the first foam sheet and the upstream breaking support,
a downstream breaking support having an input end and an output end,
a second platen located above the downstream breaking support,
a second foam sheet on the second platen having a bottom surface facing the downstream breaking support,
a second actuator operably connected to the second platen and configured to shift the second platen toward a raised position above the downstream breaking support and toward a lowered position above the downstream breaking support to selectively clamp a second portion of the log between the second foam sheet and the downstream breaking support, and
a third actuator configured to shift the input end of the downstream breaking support relative to the output end of the upstream breaking support from a first position to a second position to break the second portion of the log from the first portion of the log,
wherein the bottom surface of the first foam sheet and/or the bottom surface of the second foam sheet is at least partially coated with an elastomeric coating or at least partially covered by an elastomeric sheet.

2. The bundle breaker according to claim 1,
wherein the bottom surface of the first foam sheet and/or the bottom surface of the second foam sheet is at least partially coated with the elastomeric coating.

3. The bundle breaker according to claim 2,
wherein the elastomeric coating comprises rubber.

4. The bundle breaker according to claim 2,
wherein a thickness of the elastomeric coating is about 5 mils.

5. The bundle breaker according to claim 1,
wherein the bottom surface of the first foam sheet and/or the bottom surface of the second foam sheet is at least partially covered by the elastomeric sheet.

6. The bundle breaker according to claim 5,
wherein the elastomeric sheet comprises EPDM.

7. The bundle breaker according to claim 6,
wherein a thickness of the elastomeric sheet is about 40 mils.

8. The bundle breaker according to claim 1,
wherein the first foam sheet and/or the second foam sheet has a tensile strength of at least 10 psi.

9. The bundle breaker according to claim 8,
wherein the tensile strength is at least 15 psi.

10. The bundle breaker according to claim 1,
wherein the first foam sheet and/or the second foam sheet is configured to be compressed 10% by a load of 2.6 psi and to be compressed 50% by a load of 3.4 psi.

11. The bundle breaker according to claim 1,
wherein the first actuator includes a torque controllable servo motor,
wherein the bottom surface of the first foam sheet and/or the bottom surface of the second foam sheet is at least partially covered by the elastomeric sheet,
wherein the elastomeric sheet comprises EPDM,
wherein the first foam sheet and/or the second foam sheet has a tensile strength of at least 15 psi, and
wherein the first foam sheet and/or the second foam sheet is configured to be compressed 10% by a load of 2.6 psi and to be compressed 50% by a load of 3.4 psi.

12. The bundle breaker according to claim 1,
wherein the first actuator and/or the second actuator comprises a servo motor controllable by torque feedback.

13. A bundle breaker comprising:
an upstream breaking support having an input end and an output end,
a first platen located above the upstream breaking support,
a first foam sheet on the first platen having a bottom surface facing the upstream breaking support,
a first actuator operably connected to the first platen and configured to shift the first platen toward a raised position above the upstream breaking support and toward a lowered position above the upstream breaking support to selectively clamp a first portion of a log between the first foam sheet and the upstream breaking support,
a downstream breaking support having an input end and an output end,
a second platen located above the downstream breaking support,
a second foam sheet on the second platen having a bottom surface facing the downstream breaking support,
a second actuator operably connected to the second platen and configured to shift the second platen toward a raised position above the downstream breaking support and toward a lowered position above the downstream breaking support to selectively clamp a second portion of the log between the second foam sheet and the downstream breaking support, and
a third actuator configured to shift the input end of the downstream breaking support relative to the output end of the upstream breaking support from a first position to a second position to break the second portion of the log from the first portion of the log,
wherein a tensile strength of the first foam sheet and/or the second foam sheet is at least 15 psi, and
wherein the first foam sheet and/or the second foam sheet is compressed 10% by a load of 2.6 psi and is compressed by 50% at a load of 3.4 psi.

14. The bundle breaker according to claim 13,
wherein the bottom surface of the first foam sheet and/or the second foam sheet is at least partially covered by an elastomeric sheet.

15. The bundle breaker according to claim 14,
wherein the elastomeric sheet comprises EPDM.

16. The bundle breaker according to claim 13,
wherein the first actuator and/or the second actuator comprises a servo motor controllable by torque feedback.
